(19) United States
(12) Patent Application Publication
(10) Pub. No.: US 2012/0038871 A1
(43) Pub. Date: Feb. 16, 2012

(54) STEREOSCOPIC DISPLAY DEVICE AND LIQUID CRYSTAL BARRIER DEVICE

(75) Inventor: Yuichi Inoue, Kanagawa (JP)

(73) Assignee: Sony Corporation, Tokyo (JP)

(21) Appl. No.: 13/197,143

(22) Filed: Aug. 3, 2011

(30) Foreign Application Priority Data
Aug. 10, 2010 (JP) 2010-179557

(51) Int. Cl. G02F 1/1333; G02F 1/1343

(52) U.S. Cl. 349/122; 349/139

(57) ABSTRACT

A display device includes: a display section; and a liquid crystal barrier section including a plurality of opening-and-closing sections each configured of a liquid crystal element to extend along a predetermined direction in a light barrier surface. An orientation, in the light barrier plane, of liquid crystal molecules under no voltage application in the liquid crystal element is different from an extending direction of each of the opening-and-closing sections

### BACKGROUND

The present disclosure relates to a stereoscopic display device performing stereoscopic display by a parallax barrier method, and to a liquid crystal barrier device used for such a stereoscopic display device.

Recently, attention has been focused on a display device (stereoscopic display device) enabling stereoscopic display. In stereoscopic display, a left-eye image and a right-eye image with parallax therebetween (with different eyepoints) are displayed, and when a viewer views the respective images with two eyes, the viewer may feel a deep stereoscopic image. In addition, a display device has been developed, which displays three or more images with parallax therebetween, making it possible to provide a more natural stereoscopic image to a viewer.

Such a stereoscopic display device is roughly classified into two types: one using special glasses and the other using no special glasses. Since the special glasses are often unpleasant for a viewer, the type using no special glasses has been generally desired. A display device having no special glasses includes, for example, a lenticular lens type and a parallax barrier type (for example, see Japanese Unexamined Patent Application Publication No. 2009-104105). In such types, a plurality of images (eyepoint images) with parallax therebetween is displayed at a time, and a viewer views different images depending on a relative positional relationship (angle) between the display device and the viewer.

In the parallax barrier type, a light barrier is typically configured of liquid crystal (liquid crystal barrier). In the liquid crystal barrier (liquid crystal barrier device), liquid crystal molecules are rotated depending on applied voltage, and a refractive index of the rotated portion is thus changed, causing light modulation, and consequently light is controlled to be transmitted or blocked.

Such a liquid crystal barrier has a plurality of opening-and-closing sections for controlling light to be transmitted or blocked as described above. The respective opening-and-closing sections have electrodes for such control, and the electrodes are separately disposed from one another to be electrically isolated. This inevitably leads to a boundary region (opening-and-closing-section boundary or inter-electrode boundary) free from such electrodes between adjacent opening-and-closing sections.

However, in the opening-and-closing-section boundary, light leakage (light escape) has disadvantageously occurred through the boundary region due to an oblique electric-field generated when voltage is applied to liquid crystal molecules. When such light leakage occurs, luminance disadvantageously increases during black display, leading to reduction in display contrast and thus reduction in image quality.

It is desirable to provide a liquid crystal barrier device that may reduce light leakage through the opening-and-closing-section boundary (inter-electrode boundary), and provide a stereoscopic display device using such a liquid crystal barrier device.

### SUMMARY

A first stereoscopic display device according to an embodiment of the disclosure includes a display section and a liquid crystal barrier section. The liquid crystal barrier section has a plurality of opening-and-closing sections each configured of a liquid crystal element to extend along a predetermined direction in a light barrier surface. An orientation, in the light barrier plane, of liquid crystal molecules under no voltage application in the liquid crystal element is different from an extending direction of each of the opening-and-closing sections.

A first liquid crystal barrier device according to an embodiment of the disclosure has a plurality of opening-and-closing sections each including a liquid crystal element and extending along a predetermined direction in a light barrier surface. An orientation of liquid crystal molecules under no voltage application in the liquid crystal element is different from an extending direction of each opening-and-closing section in the light barrier surface.

In the first stereoscopic display device and the first liquid crystal barrier device according to the embodiments of the disclosure, the orientation of the liquid crystal molecules under no voltage application in the liquid crystal element is different from the extending direction of each opening-and-closing section in the light barrier surface. Consequently, when an oblique electric-field is generated during voltage application in a boundary region between the opening-and-closing sections (opening-and-closing-section boundary), the orientation of the liquid crystal molecules is hardly changed in the boundary region.

A second stereoscopic display device according to an embodiment of the disclosure includes a display section and a liquid crystal barrier section. The liquid crystal barrier section has a pair of substrates, a liquid crystal layer provided between the pair of substrates to contain liquid crystal molecules, a common electrode provided on one side of the pair of substrates on a liquid-crystal-layer side, and a plurality of electrodes provided on the other of the pair of substrates on a liquid-crystal-layer side, to extend along a predetermined direction. An orientation, in a substrate plane, of liquid crystal molecules under no voltage application is different from an extending direction of each of the electrodes.

A second liquid crystal barrier device according to an embodiment of the disclosure has a pair of substrates, a liquid crystal layer provided between the pair of substrates to contain liquid crystal molecules, a common electrode provided n one of the pair of substrates on a liquid-crystal-layer side, and a plurality of electrodes provided on the other of the pair of substrates on a liquid-crystal-layer side, to extend along a predetermined direction. An orientation, in a substrate plane, of liquid crystal molecules under no voltage application is different from an extending direction of each of the electrodes.

In the second stereoscopic display device and the second liquid crystal barrier device according to the embodiments of the disclosure, the orientation of the liquid crystal molecules under no voltage application in the liquid crystal layer is different from the extending direction of each electrode in the substrate surface. Consequently, when an oblique electric-field is generated during voltage application in a boundary region between the plurality of electrodes (inter-electrode region), the orientation of the liquid crystal molecules is hardly changed in the boundary region.

According to the first stereoscopic display device and the first liquid crystal barrier device of the embodiments of the disclosure, the orientation of the liquid crystal molecules under no voltage application in the liquid crystal element is different from the extending direction of each opening-and-closing section in the light barrier surface, allowing the liquid crystal molecules to be hardly changed in orientation during voltage application in the opening-and-closing-section boundary. This makes it possible to reduce light leakage through the opening-and-closing-section boundary, leading to improvement in display contrast and thus improvement in image quality.

According to the second stereoscopic display device and the second liquid crystal barrier device of the embodiments of the disclosure, the orientation of the liquid crystal molecules under no voltage application in the liquid crystal layer is different from the extending direction of each electrode in the substrate surface, allowing the liquid crystal molecules to be hardly changed in orientation during voltage application in the inter-electrode region. This makes it possible to reduce light leakage through the inter-electrode region, leading to improvement in display contrast and thus improvement in image quality.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram illustrating a general configuration example of a stereoscopic display device according to a first embodiment of the disclosure.

FIGS. 2A and 2B are an exploded perspective diagram and a side diagram illustrating the general configuration example of the stereoscopic display device shown in FIG. 1.

FIG. 3 is a block diagram illustrating a detailed configuration example of each of a display section and a display drive section shown in FIG. 1.

FIG. 4 is a circuit diagram illustrating a detailed configuration example of a pixel shown in FIG. 3.

FIGS. 5A and 5B are a plan diagram and a section diagram, respectively, illustrating a detailed configuration example of a liquid crystal barrier shown in FIG. 1.

FIG. 6 is a plan diagram illustrating an operation state example of the liquid crystal barrier shown in FIGS. 5A and 5B in stereoscopic display.

FIGS. 7A to 7C are schematic diagrams for explaining a relationship between an arrangement direction of transparent electrodes and an orientation of liquid crystal molecules in the liquid crystal barrier shown in FIGS. 5A and 5B by comparison with a comparative example.

FIGS. 8A to 8C are schematic diagrams for explaining display operation of the stereoscopic display device shown in FIGS. 2A and 2B.

FIGS. 9A and 9B are schematic diagrams for explaining stereoscopic display operation of the stereoscopic display device shown in FIGS. 2A and 2B.

FIGS. 10A to 10C are diagrams for explaining an example of a relationship between the orientation of the liquid crystal molecules and light leakage in the liquid crystal barrier.

FIGS. 11A to 11D are diagrams for explaining another example of the relationship between the orientation of the liquid crystal molecules and light leakage in the liquid crystal barrier.

FIGS. 12A to 12C are exploded perspective diagrams illustrating arrangement examples of polarization transmission axes and absorption axes of polarizing plates of each of the display section and the liquid crystal barrier.

FIGS. 13A to 13C are plan diagrams illustrating configuration examples of a liquid crystal barrier of a stereoscopic display device according to a second embodiment.

FIGS. 14A to 14C are plan diagrams illustrating configuration examples of an opening-and-closing section of the liquid crystal barrier shown in FIGS. 13A to 13C, together with configuration example of pixels in the display section.

FIGS. 15A and 15B are schematic diagrams for explaining a relationship between an arrangement direction of transparent electrodes and an orientation of liquid crystal molecules in the liquid crystal barrier shown in FIGS. 13A to 13C.

FIGS. 16A and 16B are schematic diagrams for explaining right-hand operation and left-hand operation of a liquid crystal molecule.

FIGS. 17A and 17B are graphs illustrating an example of a relationship between the orientation of the liquid crystal molecules in the liquid crystal barrier and transmittances at various positions in a screen.

FIGS. 18A and 18B are graphs illustrating an example of a relationship between the orientation of the liquid crystal molecules in the liquid crystal barrier and the amount of light leakage through the liquid crystal barrier.

FIGS. 19A and 19B are graphs illustrating another example of the relationship between the orientation of the liquid crystal molecules in the liquid crystal barrier and the amount of light leakage through the liquid crystal barrier.

FIGS. 20A and 20B are an exploded perspective diagram and a side diagram, respectively, illustrating a general configuration example of a stereoscopic display device according to a modification.

FIGS. 21A and 21B are schematic diagrams for explaining stereoscopic display operation of the stereoscopic display device shown in FIGS. 20A and 20B.

### DETAILED DESCRIPTION OF EMBODIMENTS

Hereinafter, embodiments of the disclosure will be described in detail with reference to drawings. Description is made in the following order.

1. First embodiment (example of extending each opening-and-closing section of a liquid crystal barrier along a vertical line direction)

2. Second embodiment (example of extending each opening-and-closing section of a liquid crystal barrier along an oblique direction)

3. Modification (example of disposing a liquid crystal barrier between a backlight section and a display section)

### First Embodiment

### General Configuration of Stereoscopic Display Device 1

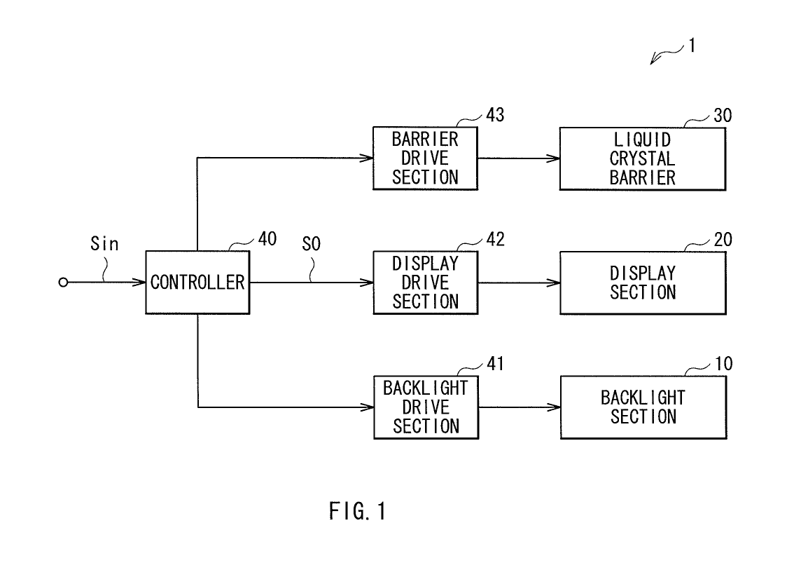

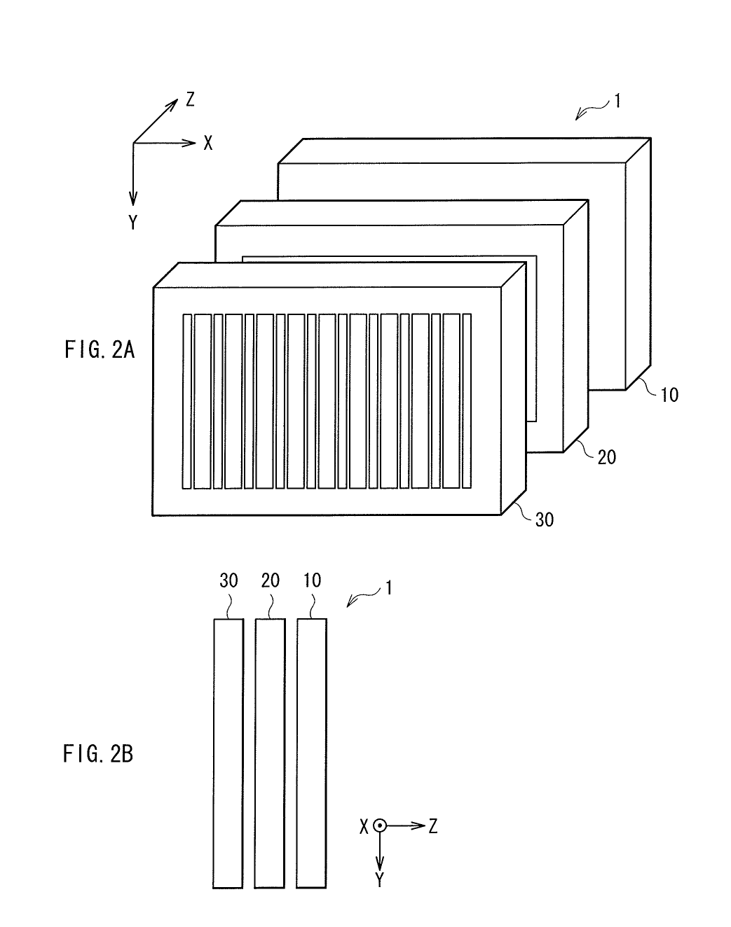

FIG. 1 is a block diagram illustrating a general configuration of a stereoscopic display device (stereoscopic display device 1) according to a first embodiment of the disclosure. FIGS. 2A and 2B are an exploded perspective diagram (FIG. 2A) and a side diagram (Y-Z side diagram: FIG. 2B)), respectively, illustrating the general configuration of the stereoscopic display device 1. The stereoscopic display device 1 may perform stereoscopic display (three-dimensional display) by a parallax barrier method based on a video signal Sin inputted from the outside.

The stereoscopic display device 1 includes a backlight section 10, a display section 20, a liquid crystal barrier 30 (liquid crystal barrier device), a controller 40, a backlight drive section 41, a display drive section 42, and a barrier drive section 43, as shown in FIG. 1. In the stereoscopic display device 1, the backlight section 10, the display section 20, and the liquid crystal barrier 30 are disposed in this order along a Z-axis direction, as shown in FIGS. 2A and 2B. In other words, light is emitted from the backlight section 10 and received by a viewer through the display section 20 and the liquid crystal barrier 30 in this order.

The controller 40 generates and supplies a control instruction to each of the backlight drive section 41, the display drive section 42, and the barrier drive section 43 based on the video signal Sin, and controls the sections to operate in synchronization with one another. Specifically, the controller 40 supplies a backlight control instruction to the backlight drive section 41, supplies a video signal S0 to the display drive section 42 based on the video signal Sin, and supplies a barrier control instruction to the barrier drive section 43. When the stereoscopic display device 1 performs stereoscopic display, the video signal S0 includes, for example, a video signal including a plurality of eyepoint images as described later.

### (Backlight Section 10 and Backlight Drive Section 41)

The backlight section 10, which corresponds to a light source section emitting light to the display section 20, is configured of a light emitting element such as a cold cathode fluorescent lamp (CCFL) or light emitting diodes (LEDs).

The backlight drive section 41 drives (performs emission-drive of) the backlight section 10 based on the backlight control instruction supplied from the controller 40.

### (Display Section 20 and Display Drive Section 42)

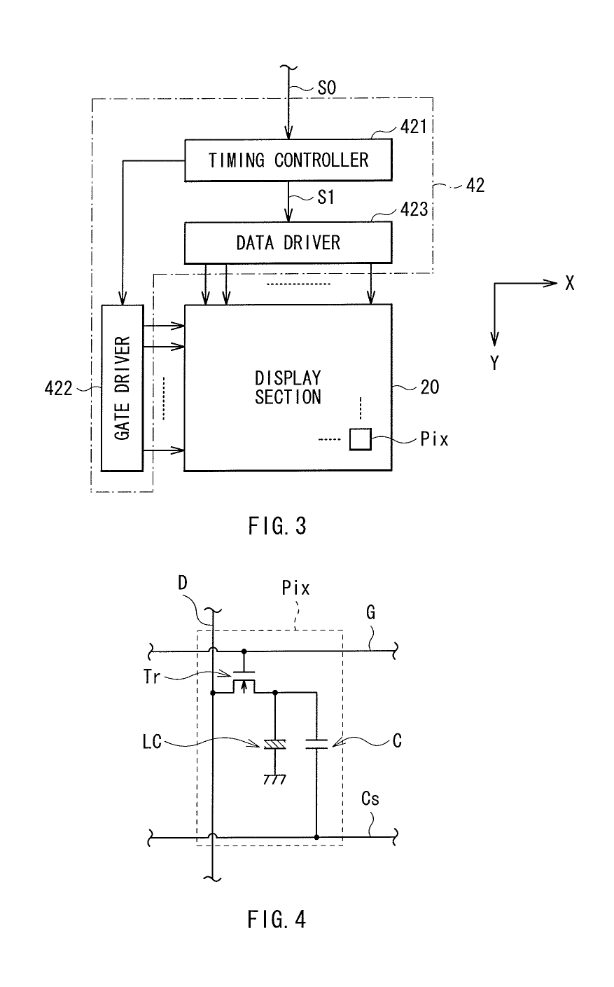

The display section 20 is configured of a liquid crystal display section that modulates light emitted from the backlight section 10 based on a display control signal supplied from the display drive section 42, and thus performs video display based on the video signal S0. The display section 20 may display a plurality of eyepoint images in a manner including space division manner (here, space-and-time division manner) as described later. The display section 20 has a plurality of pixels Pix arranged generally in a matrix as shown in FIG. 3. In other words, the pixels Pix are arranged in the display section 20 along each of a horizontal line direction (here, X-axis direction) and a vertical line direction (here, Y-axis direction).

FIG. 4 illustrates a circuit configuration example of each pixel Pix. Each pixel Pix has a liquid crystal element LC, a TFT (Thin Film Transistor) element Tr, and an auxiliary capacitance element C. Each pixel Pix is connected with a gate line G for line-sequentially selecting a pixel to be driven, with a data line D for supplying a pixel signal (pixel signal supplied from a data driver 423 described later) to the pixel to be driven, and with an auxiliary capacitance line Cs.

The liquid crystal element LC performs display operation according to a pixel signal supplied from the data line D to an end of the element LC via the TFT element Tr. The liquid crystal element LC includes a liquid crystal layer (not shown), including, for example, VA (Vertical Alignment)-mode or TN (Twisted Nematic)-mode liquid crystal, sandwiched by a pair of electrodes (not shown). One of the pair of electrodes (one end) of the liquid crystal element LC is connected to a drain of the TFT element Tr and to one end of the auxiliary capacitance element C, and the other (the other end) is grounded. The auxiliary capacitance element C stabilizes charge accumulated in the liquid crystal element LC. One end of the auxiliary capacitance element C is connected to one end of the liquid crystal element LC and to the drain of the TFT element Tr, and the other end of the element C is connected to an auxiliary capacitance line Cs. The TFT element Tr is a switching element for supplying a pixel signal based on the video signal S0 to the respective one ends of the liquid crystal element LC and the auxiliary capacitance element C, and is configured of MOS-FET (Metal Oxide Semiconductor-Field Effect Transistor). A gate of the TFT element Tr is connected to the gate line G, and a source thereof is connected to the data line D, and the drain thereof is connected to the respective one ends of the liquid crystal element LC and the auxiliary capacitance element C.

The display drive section 42 drives (performs display-drive of) the display section 20 based on the video signal S0 supplied from the controller 40, and has a timing controller 421, a gate driver 422, and a data driver 423 as shown in FIG. 3.

The timing controller 421 controls drive timing of each of the gate driver 422 and the data driver 423, and supplies a video signal S1 to the data driver 423 based on the video signal S0 supplied from the controller 40.

The gate driver 422 sequentially selects pixels Pix in the display section 20 for each of horizontal lines (rows) in accordance with timing control performed by the timing controller 421 so that line-sequential scan is performed.

The data driver 423 supplies a pixel signal based on the video signal 51 to each pixel Pix in the display section 20. Specifically, the data driver 423 performs D/A (digital to analog) conversion based on the video signal S1, and thus generates the pixel signal as an analog signal and supplies the pixel signal to each pixel Pix.

### (Liquid Crystal Barrier 30 and Barrier Drive Section 43)

The liquid crystal barrier 30 has a plurality of opening-and-closing sections (opening-and-closing sections 31 and 32 described later) each including a liquid crystal element described later, and has a function of transmitting or blocking light emitted from the backlight section 10 and transmitted through the display section 20.

The barrier drive section 43 drives (performs barrier-drive of) the liquid crystal barrier 30 based on the barrier control instruction supplied from the controller 40.

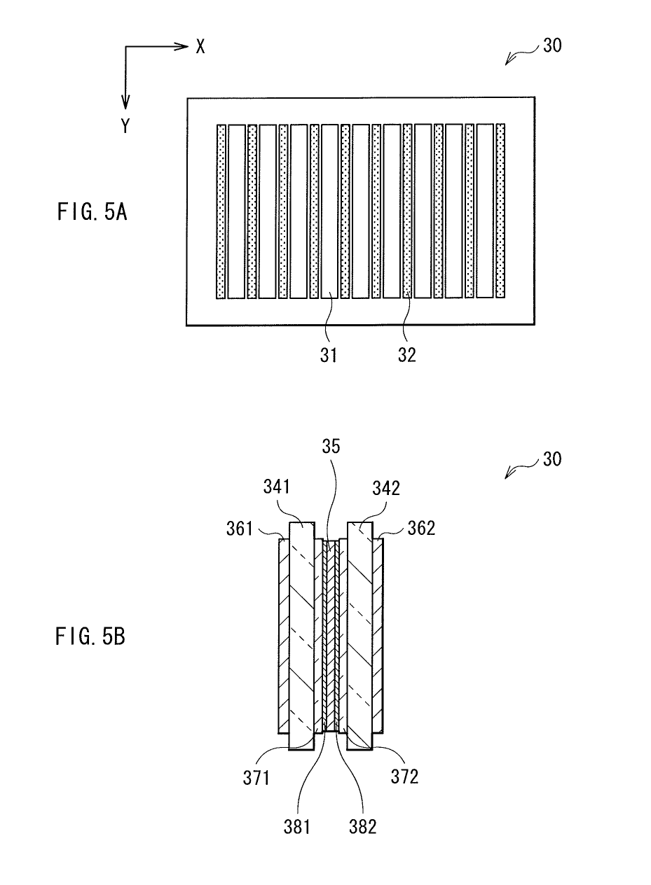

FIGS. 5A and 5B illustrate a detailed configuration of the liquid crystal barrier 30, where FIG. 5A illustrates a planar configuration (X-Y planar configuration), and FIG. 5B illustrates a sectional configuration (Y-Z sectional configuration). In this example, it is assumed that the liquid crystal barrier 30 performs normally white operation. In other words, the liquid crystal barrier 30 transmits light while being not driven (under no voltage application).

As shown in FIG. 5A, the liquid crystal barrier 30 has a plurality of opening-and-closing sections 31 and 32, each section 31 or 32 extending along a predetermined direction in a light barrier surface (here, X-Y plane) and transmitting or blocking light. Specifically, the opening-and-closing sections 31 or 32 have a rectangular shape (with a major axis along a Y-axis direction) extending along the Y-axis direction (vertical-line direction of the display section 20) each, and are arranged in parallel along an X-axis direction (horizontal-line direction of the display section 20). While the opening-and-closing sections 31 or 32 extend along the vertical-line direction of the display section 20 herein, this is not limitative, and the sections may extend in an approximately-vertical-line direction. The opening-and-closing sections 31 or 32 perform different operation depending on whether the stereoscopic display device 1 performs normal display (two-dimensional display) or stereoscopic display. Specifically, the opening-and-closing sections 31 are in an open state (light-transmitting state) during normal display of the stereoscopic display device 1, and in a closed state (light-blocking state) during stereoscopic display thereof, as described later. On the other hand, the opening-and-closing sections 32 are in an open state (light-transmitting state) during normal display of the stereoscopic display device 1, and time-divisionally opened and closed during stereoscopic display thereof, as described later.

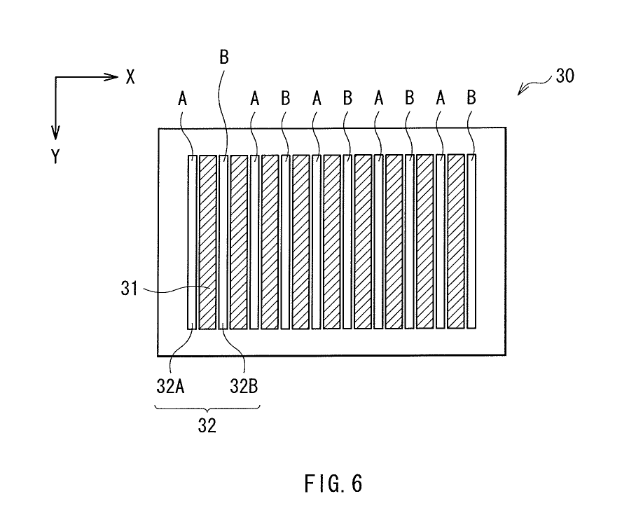

FIG. 6 schematically illustrates an example of an operation state of the liquid crystal barrier 30 during stereoscopic display. Here, while the opening-and-closing sections 31 are in a closed state (light-blocking state), the opening-and-closing sections 32 are time-divisionally opened and closed, as described above. In the figure, closed regions of the opening-and-closing sections 31 are shaded. The opening-and-closing sections 32 have two groups (groups A and B), in each of which opening-and-closing sections perform opening-and-closing operation at the same timing. Specifically, the opening-and-closing sections 32 include opening-and-closing sections 32A belonging to the group A performing opening-and-closing operation at one timing, and opening-and-closing sections 32B belonging to the group B performing opening-and-closing operation at the other timing. The barrier drive section 43 drives the liquid crystal barrier such that a plurality of opening-and-closing sections 32A or 32B belonging to the same group perform opening-and-closing operation at the same timing during stereoscopic display. Specifically, the barrier drive section 43 drives the liquid crystal barrier such that the opening-and-closing sections 32A belonging to the group A and the opening-and-closing sections 32B belonging to the group B perform opening-and-closing operation time-divisionally alternately.

The liquid crystal barrier 30 (opening-and-closing sections 31 or 32 thereof) is configured of liquid crystal elements as shown in FIG. 5B. Specifically, the liquid crystal barrier 30 includes a transparent substrate 341, a transparent substrate 342 oppositely disposed to the transparent substrate 341, and a liquid crystal layer 35 interposed between the transparent substrates 341 and 342. The respective transparent substrates 341 and 342 (a pair of substrates) is formed of, for example, glass. For example, liquid crystal molecules (liquid crystal molecules 350 described later) in the liquid crystal layer 35 are in TN arrangement or homogenous arrangement (parallel arrangement).

Transparent electrodes 371 and 372 including, for example, ITO (Indium Tin Oxide) are formed on a surface on a liquid crystal layer 35 side of the transparent substrate 341 and on a surface on a liquid crystal layer 35 side of the transparent substrate 342, respectively. Here, for example, the transparent electrode 371 formed on the transparent substrate 341 is provided as a common electrode between the opening-and-closing sections 31 and 32. In contrast, a plurality of transparent electrodes 372 (a plurality of electrodes) formed on the transparent substrate 342 are separately provided at positions corresponding to the opening-and-closing sections 31 and 32. The transparent electrodes 372 are disposed separately from one another to be electrically insulated, leading to a boundary region (opening-and-closing-section boundary (inter-electrode region) 33 described later) with no transparent electrode 372 between adjacent opening-and-closing sections 31 and 32. Such transparent electrodes 371 and 372 and the liquid crystal layer 35 configure the opening-and-closing sections 31 and 32.

Alignment films 381 and 382 are formed on a surface on a liquid crystal layer 35 side of the transparent electrode 371 and on a surface on a liquid crystal layer 35 side of the transparent electrode 372, respectively, in order to align the liquid crystal molecules 350 in the liquid crystal layer 35 in a predetermined direction. Specifically, the alignment films 381 and 382 are subjected to rubbing treatment along an in-plane, predetermined direction in a manufacturing process, so that the liquid crystal molecules 350 under no voltage application are aligned in a predetermined direction in a substrate surface (in a light barrier surface).

On the other hand, a polarizing plate 361 is provided on a surface of the transparent substrate 341 on a side opposite to the liquid crystal layer 35, and a polarizing plate 362 is provided on a surface of the transparent substrate 342 on a side opposite to the liquid crystal layer 35. While not shown, in FIG. 5B, the display section 20 and the backlight section 10 are disposed in order as shown in FIG. 2B on the right of the liquid crystal barrier 30 (on the right of the polarizing plate 362: in a positive direction of the Z-axis). In other words, the transparent substrate 341, the transparent electrode 371, the alignment film 381, and the polarizing plate 361 are disposed on a viewer side (light output side), and the transparent substrate 342, the transparent electrode 372, the alignment film 382, and the polarizing plate 362 are disposed on a display section 20 side (light input side).

Opening-and-closing operation of the opening-and-closing sections 31 or 32 of the liquid crystal barrier 30 is the same as display operation of the display section 20. In other words, light, which has been emitted from the backlight section 10 and transmitted by the display section 20, is formed into linearly polarized light in a direction determined by the polarizing plate 362 and then enters the liquid crystal layer 35. In the liquid crystal layer 35, a direction of the liquid crystal molecules 350 is changed in a certain response time depending on potential difference supplied to the transparent electrodes 371 and 372. Light, which has entered such a liquid crystal layer 35, is changed in polarization state depending on a current alignment state of the liquid crystal molecules 350. Then, light is transmitted through the liquid crystal layer 35, and then enters the polarizing plate 361, through which only light in a particular polarization direction passes. In this way, intensity modulation of light is performed in the liquid crystal layer 35.

According to such a configuration, in the case of normally white operation, when voltage is applied to the transparent electrodes 371 and 372 and thus potential difference is increased therebetween, light transmittance of the liquid crystal layer 35 is decreased, and consequently the opening-and-closing sections 31 and 32 are into a light-blocking state (closed state). In contrast, when potential difference is decreased between the transparent electrodes 371 and 372, light transmittance of the liquid crystal layer 35 is increased, and consequently the opening-and-closing sections 31 and 32 are into a light-transmitting state (open state).

While it is assumed that the liquid crystal barrier 30 performs normally white operation in this example, this is not limitative. For example, the liquid crystal barrier 30 may perform normally black operation instead. In such a case, when potential difference is increased between the transparent electrodes 371 and 372, the opening-and-closing sections 31 and 32 are into an open state (light-transmitting state), whereas when potential difference is decreased between the transparent electrodes 371 and 372, the opening-and-closing sections 31 and 32 are into a light-blocking state (closed state). Incidentally, normally white operation or normally black operation may be optionally selected, for example, through appropriately setting each polarizing plate and liquid crystal alignment.

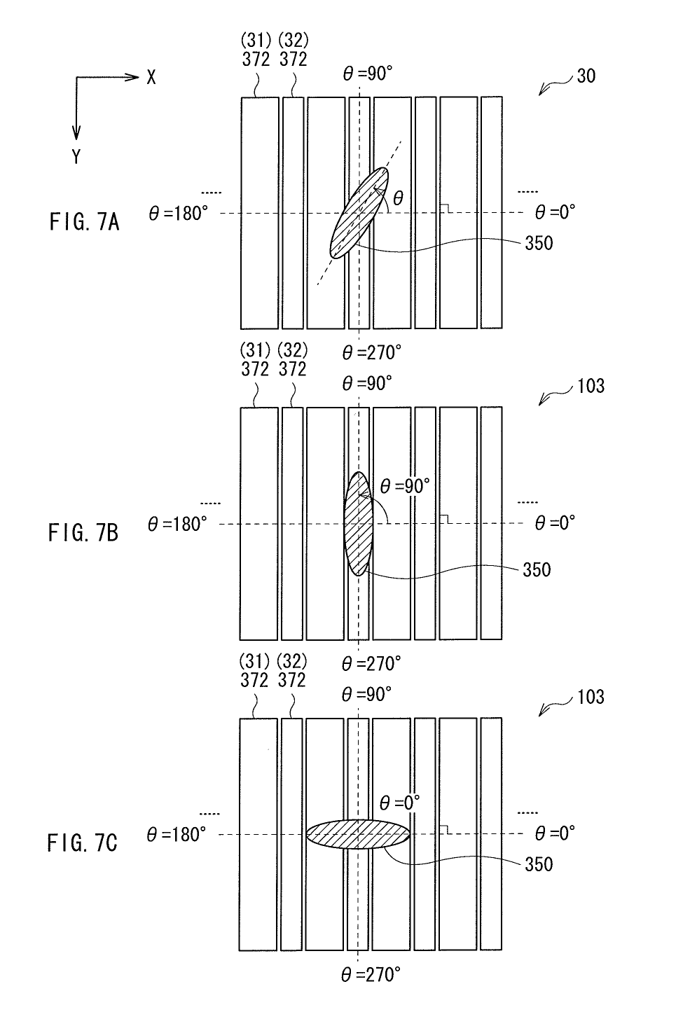

In the liquid crystal barrier 30 of the embodiment, an orientation of the liquid crystal molecules 350 under no voltage application in the liquid crystal element (liquid crystal layer 35) is different from (has a predetermined angle to) an extending direction of the opening-and-closing sections 31 or 32 (extending direction of the transparent electrodes 372; the same below) in a light barrier surface (in a substrate surface; the same below). Specifically, for example, an orientation of the liquid crystal molecules 350 in a state of no voltage application (here, light-transmitting state) is different from an extending direction (here, Y-axis direction) of the opening-and-closing sections 31 or 32 in the light barrier surface (X-Y plane), as schematically shown in FIG. 7A. In other words, an angle θ formed by an arrangement direction (here, X-axis direction) of the opening-and-closing sections 31 or 32 and an orientation of the liquid crystal molecules 350 has a value different from 90 or 270 degrees unlike a liquid crystal barrier 103 according to a comparative example shown in FIG. 7B. This means that θ is not 90 or 270 degrees (0°≦θ<90°, 90°<θ<270°, and) 270°<θ≦360° (=0°. Here, “orientation of the liquid crystal molecules 350” means that, for example, when the liquid crystal molecules 350 are in TN alignment (twisted alignment), an orientation (rubbing direction) on an alignment film (here, alignment film 382) on a side where a plurality of electrodes (here, the plurality of transparent electrodes 372) corresponding to the plurality of opening-and-closing sections 31 and 32 are provided, which is the same below.

Moreover, in the liquid crystal barrier 30 of the embodiment, for example, the orientation of the liquid crystal molecules 350 is desirably approximately orthogonal (here, orthogonal) to the extending direction of the opening-and-closing sections 31 or 32 in the light barrier surface (X-Y plane) as shown in FIG. 7C. In other words, the angle θ formed by the arrangement direction of the opening-and-closing sections 31 or 32 and the orientation of the liquid crystal molecules 350 is desirably approximately 0 degrees (the arrangement direction is approximately parallel to the orientation) (here, θ=0° (parallel to each other)). This makes it possible to effectively reduce light leakage through an opening-and-closing boundary 33 as described later.

### [Effects and Advantage of Stereoscopic Display Device 1]

### (1. Display Operation)

In the stereoscopic display device 1, first, the controller 40 generates and supplies a control instruction to each of the backlight drive section 41, the display drive section 42, and the barrier drive section 43 based on the video signal Sin supplied from the outside, and thus controls the sections to operate in synchronization with one another. Next, the backlight drive section 41 drives (performs emission-drive of) the backlight section 10 based on the backlight control instruction supplied from the controller 40. The backlight section 10 emits surface-emitted light to the display section 20. The display drive section 42 drives (performs display-drive of) the display section 20 based on the video signal S0 supplied from the controller 40. The display section 20 modulates light emitted from the backlight section 10 based on a display control signal supplied from the display drive section 42, thereby performing video display based on the video signal S0. The barrier drive section 43 drives (performs barrier-drive of) the liquid crystal barrier 30 based on the barrier control instruction supplied from the controller 40. The liquid crystal barrier 30 transmits or blocks light, which has been emitted from the backlight section 10 and transmitted through the display section 20 in the above way, in each opening-and-closing section 31 or 32.

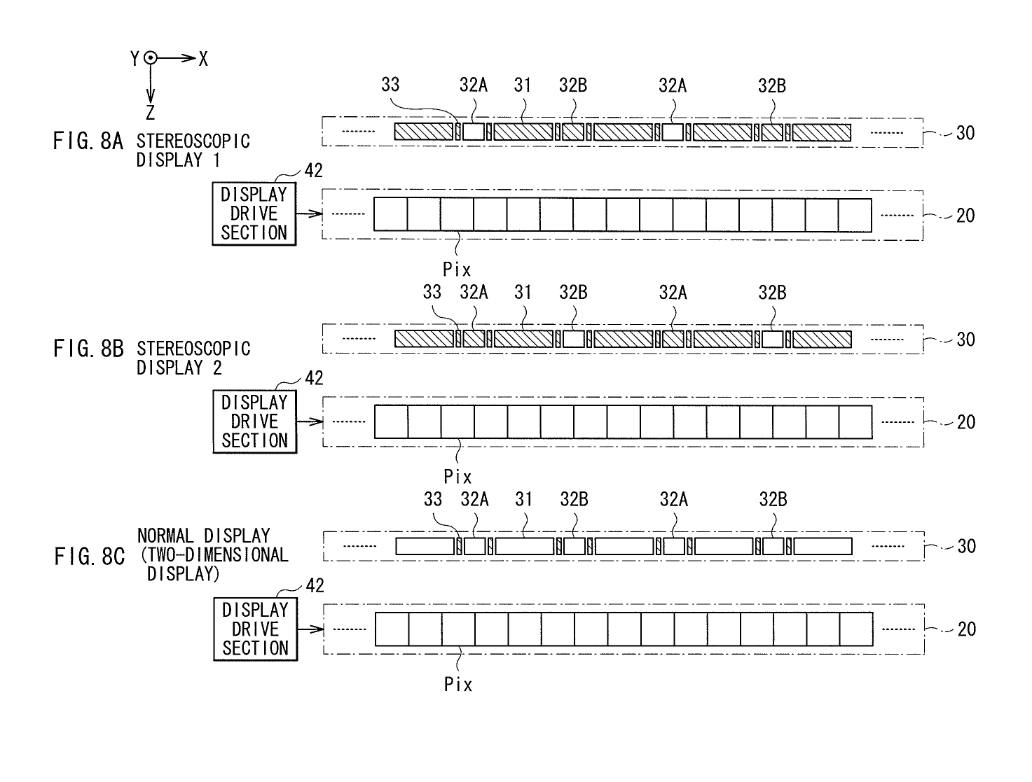

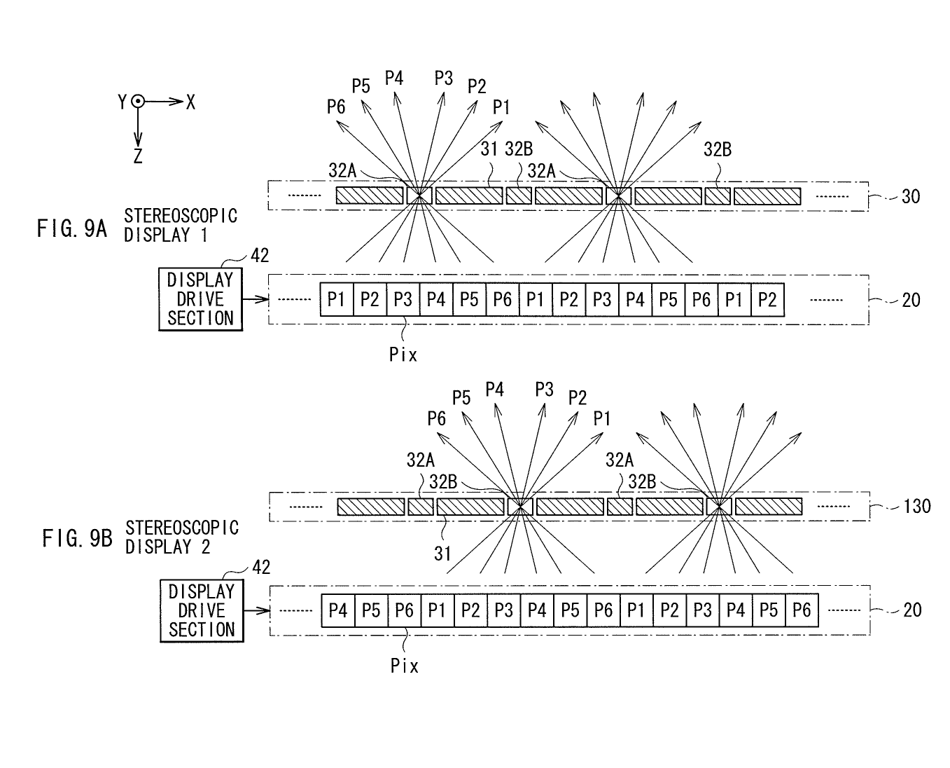

Here, stereoscopic display and normal display (two-dimensional display) of the stereoscopic display device 1 are described in detail with reference to FIGS. 8A to 8C and 9A and 9B. FIGS. 8A to 8C schematically illustrate, using a sectional structure, a state of the liquid crystal barrier 30 in each of stereoscopic display and normal display (two-dimensional display). FIG. 8A shows a state of stereoscopic display (stereoscopic display 1), FIG. 8B shows another state of stereoscopic display (stereoscopic display 2), and FIG. 8C shows a state of normal display (two-dimensional display). In this example, the opening-and-closing sections 32A or 32B are provided by one for six pixels Pix of the display section 20. In FIGS. 8A to 8C and 9A and 9B, the liquid crystal barrier 30 is shaded particularly in light-blocking portions.

First, in the case of normal display (two-dimensional display), the liquid crystal barrier 30 is controlled to allow both the opening-and-closing sections 31 and the opening-and-closing sections 32 (opening-and-closing sections 32A and 32B) to be continuously in the open state (light-transmitting state) as shown in FIG. 8C. This allows a viewer to directly view a normal two-dimensional image displayed on the display section 20 based on the video signal S0.

In the case of stereoscopic display, the liquid crystal barrier 30 is controlled to allow the opening-and-closing sections 32 (opening-and-closing sections 32A and 32B) to time-divisionally perform opening-and-closing operation, and allows the opening-and-closing sections 31 to be continuously in the closed state (light-blocking state) as shown in FIGS. 8A and 8B. Here, the display section 20 displays a plurality of eyepoint images space-divisionally and time-divisionally.

Specifically, in the case of stereoscopic display 1 as shown in FIG. 8A, the opening-and-closing sections 32A are opened, and opening-and-closing sections 32B are closed. In the display section 20, six adjacent pixels Pix disposed at positions corresponding to such opened opening-and-closing sections 32A perform display in correspondence to six eyepoint images in the video signal S0. In detail, for example, the pixels Pix of the display section 20 display pixel information P1 to P6 corresponding to the respective six eyepoint images in the video signal S0, as shown in FIG. 9A. Here, light from each of the pixels Pix of the display section 20 is outputted with an angle limited by each of the opening-and-closing sections 32A. For example, a viewer views pixel information P3 by a left eye and pixel information P4 by a right eye, making it possible for the viewer to view a stereoscopic image.

Similarly, in the case of stereoscopic display 2 as shown in FIG. 8B, the opening-and-closing sections 32B are opened, and opening-and-closing sections 32A are closed. In the display section 20, six adjacent pixels Pix disposed at positions corresponding to such opened opening-and-closing sections 32B perform display in correspondence to six eyepoint images in the video signal SB. In detail, for example, the pixels Pix of the display section 20 display pixel information P1 to P6 corresponding to the respective six eyepoint images in the video signal SB, as shown in FIG. 9B. Here, light from each of the pixels Pix of the display section 20 is outputted with an angle limited by each of the opening-and-closing sections 32B. For example, a viewer views pixel information P3 by a left eye and pixel information P4 by a right eye, making it possible for the viewer to view a stereoscopic image.

In this way, a viewer views different kinds of pixel information between the pixel information P1 to P6 between two eyes, making it possible for the viewer to feel a stereoscopic image. In addition, the opening-and-closing sections 32A and 32B are time-divisionally alternately opened for image display, allowing a viewer to view images displayed at positions offset from each other in an average manner. Accordingly, the stereoscopic display device 1 enables resolution twice as high as resolution in a case where only the opening-and-closing sections 32A are provided. In other words, resolution of the stereoscopic display device 1 is relatively high, ⅓ (=⅙*2) of resolution in the case of two-dimensional display.

### (2. Effects of Liquid Crystal Barrier 30)

Next, effects of the liquid crystal barrier 30 as one of features of the embodiment of the disclosure are described in detail in comparison with a comparative example.

(Relationship between Orientation of Liquid Crystal Molecules 350 and Light Leakage in Liquid Crystal Barrier 30)

First, in a liquid crystal barrier in the past, light leakage (light escape) has disadvantageously occurred through the opening-and-closing-section boundary 33 due to an oblique electric-field generated when voltage is applied to the liquid crystal molecules 350. When such light leakage occurs, luminance disadvantageously increases during black display, leading to reduction in display contrast and thus reduction in image quality.

Thus, in the liquid crystal barrier 30 of the embodiment, the orientation of the liquid crystal molecules 350 under no voltage application is different from (has a predetermined angle to) the extending direction of the opening-and-closing sections 31 or 32 in a light barrier surface, for example, as shown in FIGS. 7A and 7C. In other words, an angle θ formed by the arrangement direction (X-axis direction) of the opening-and-closing sections 31 or 32 and the orientation of the liquid crystal molecules 350 has a value different from 90 or 270 degrees unlike the liquid crystal barrier 103 according to the comparative example shown in FIG. 7B. Consequently, in the liquid crystal barrier 30, when an oblique electric-field is generated during voltage application in the boundary region (opening-and-closing-section boundary 33) between the opening-and-closing sections 31 and 32, the orientation of the liquid crystal molecules 350 is hardly changed compared with the liquid crystal barrier 103 according to the comparative example, leading to reduction in light leakage through the opening-and-closing boundary 33 compared with the liquid crystal barrier 103.

Moreover, in the liquid crystal barrier 30 of the embodiment, the orientation of the liquid crystal molecules 350 is desirably approximately orthogonal (here, orthogonal) to the extending direction of the opening-and-closing sections 31 or 32 in the light barrier surface as shown in FIG. 7C. In other words, the angle θ formed by the arrangement direction of the opening-and-closing sections 31 or 32 and the orientation of the liquid crystal molecules 350 is desirably approximately 0 degrees (the arrangement direction is approximately parallel to the orientation) (here, θ=0° (parallel to each other)). In the case of such a configuration, when the oblique electric-field is generated during voltage application in the opening-and-closing-section boundary 33, the orientation of the liquid crystal molecules 350 is further hardly changed, and consequently light leakage through the opening-and-closing boundary 33 is further (more effectively) reduced.

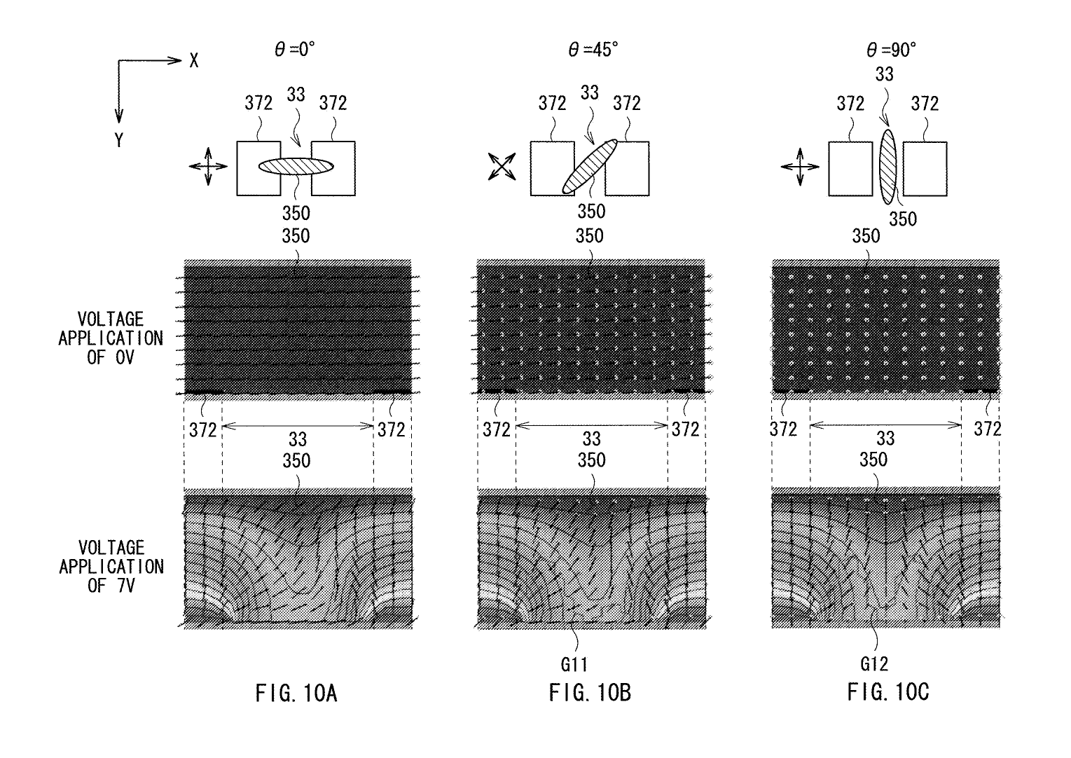

FIGS. 10A to 10C illustrate an example of a relationship between the orientation of the liquid crystal molecules 350 and light leakage in the liquid crystal barrier 30, which corresponds to an example of a case of liquid crystal molecules 350 in homogenous alignment (parallel alignment). FIG. 10A shows the example in the case of θ=0°, FIG. 10B shows an example in the case of θ=45°, and FIG. 10C shows a case of θ=90° (comparative example). In addition, each of FIGS. 10A to 10C shows, in order from above, a schematic diagram illustrating the orientation of the liquid crystal molecules 350, a simulation diagram of an alignment state of the liquid crystal molecules 350 when voltage of 0 V (light-transmitting voltage) is applied between the transparent electrodes 371 and 372 (when no voltage is applied), and a simulation diagram of an alignment state of the liquid crystal molecules 350 when voltage of 7 V (here, light-blocking voltage) is applied between the transparent electrodes 371 and 372. In the schematic diagrams illustrating the orientation of the liquid crystal molecules 350, arrows represent respective polarization transmission axes of the polarizing plates 361 and 362.

From FIGS. 10A to 10C, in the case of FIG. 10C according to the comparative example (θ=90°), an oblique electric-field is generated in the opening-and-closing-section boundary 33 during voltage application of 7 V, and the orientation of the liquid crystal molecules 350 is greatly changed (twisted) in the boundary 33 from that in voltage application of 0 V due to a direction of the generated oblique electric-field. This allows a large amount of light leakage (light escape) to occur through the opening-and-closing-section boundary 33 in the comparative example, as indicated by a sign G12 in FIG. 10C. In contrast, in the case of FIG. 10A or 10B according to the example of the embodiment (θ=0° or 45°), when the oblique electric-field is generated during voltage application of 7 V in the opening-and-closing-section boundary 33, the orientation of the liquid crystal molecules 350 is little changed in the boundary 33 from that in voltage application of 0 V compared with the comparative example. Particularly, in the case of θ=0° shown in FIG. 10A, when an oblique electric-field is generated during voltage application of 7 V in the opening-and-closing-section boundary 33, the orientation of the liquid crystal molecules 350 is not (scarcely) changed in the boundary 33 from that in voltage application of 0 V. In the example shown in FIG. 10B, light leakage through the opening-and-closing-section boundary 33 is reduced compared with the comparative example as indicated by a sign G11 in the figure. In the example shown in FIG. 10A, light leakage through the opening-and-closing-section boundary 33 hardly occurs (is prevented).

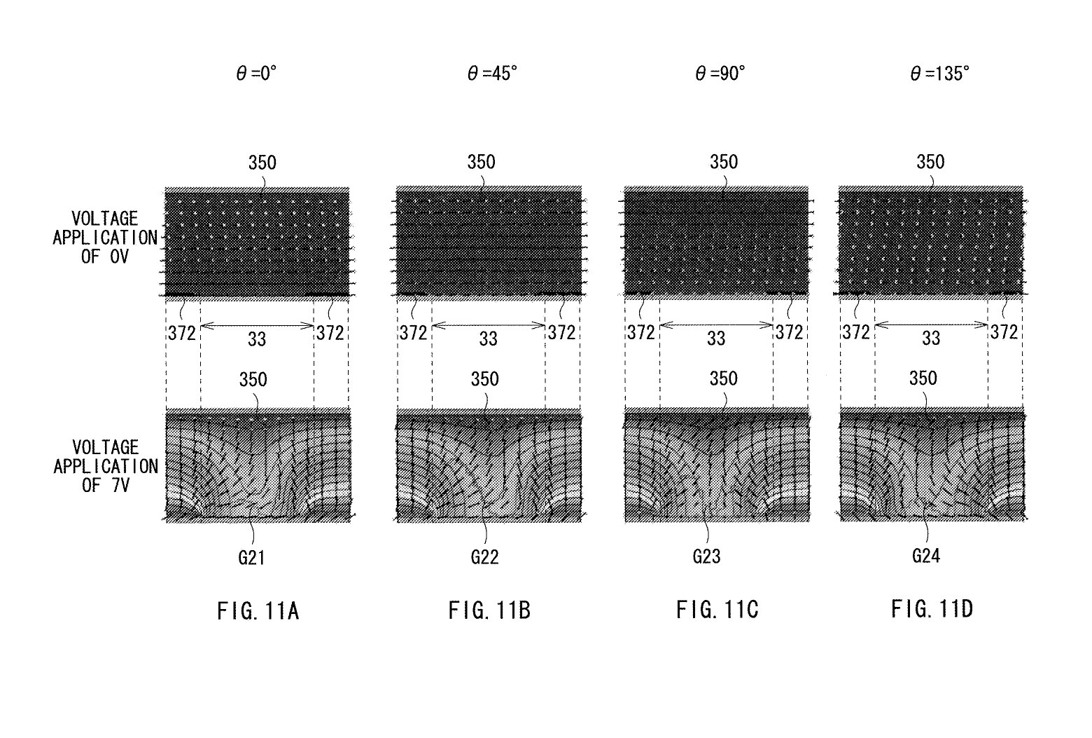

Next, FIGS. 11A to 11D illustrate an example of another relationship between the orientation of the liquid crystal molecules 350 and light leakage in the liquid crystal barrier 30, which corresponds to an example of a case of liquid crystal molecules 350 in TN alignment. FIG. 11A shows the example in the case of θ=0°, FIG. 11B shows an example in the case of θ=45°, FIG. 11C shows a case of θ=90° (comparative example), and FIG. 11D shows an example in the case of θ=135°. In addition, in the same way as FIGS. 10A to 10C, each of FIGS. 11A to 11D shows, in order from above, a simulation diagram of an alignment state of the liquid crystal molecules 350 when voltage of 0 V (light-transmitting voltage) is applied between the transparent electrodes 371 and 372, and a simulation diagram of an alignment state of the liquid crystal molecules 350 when voltage of 7 V (here, light-blocking voltage) is applied between the transparent electrodes 371 and 372. In the case of TN alignment, an orientation of the liquid crystal molecules 350 is changed depending on positions in a thickness direction of the liquid crystal layer 35, as known from FIGS. 11A to 11D. Specifically, for example, in the example shown in FIG. 11A, θ is about 0 degrees near a boundary with the transparent electrode 372, about −45 degrees near the center of thickness (center of cell thickness), and about −90 degrees near a boundary on a counter side of the transparent electrode 372 (on a transparent electrode 371 side). Thus, since “orientation of the liquid crystal molecules 350” is defined as orientation on the transparent electrode 372 side as described before, in the case of the TN alignment, angle θ on the transparent electrode 372 side is also used as the described angle θ to specify the examples and the comparative example.

From FIGS. 11A to 11D, in the case of FIG. 11C according to the comparative example)(θ=90°, an oblique electric-field is generated in the opening-and-closing-section boundary 33 during voltage application of 7 V, and the orientation of the liquid crystal molecules 350 is greatly changed in the boundary 33 from that in voltage application of 0 V due to a direction of the generated oblique electric-field. This allows a large amount of light leakage (light escape) to occur through the opening-and-closing-section boundary 33 in the comparative example, as indicated by a sign G23 in FIG. 11C. In contrast, in the case of FIG. 11A, 11B, or 11D according to the example of the embodiment (θ=0°, 45°, or 135°), when the oblique electric-field is generated during voltage application of 7 V in the opening-and-closing-section boundary 33, the orientation of the liquid crystal molecules 350 is little changed in the boundary 33 from that in voltage application of 0 V compared with the comparative example. Particularly, in the case of θ=0° shown in FIG. 11A, when an oblique electric-field is generated during voltage application of 7 V in the opening-and-closing-section boundary 33, the orientation of the liquid crystal molecules 350 is not (scarcely) changed in the boundary 33 from that in voltage application of 0 V. In the example shown in FIG. 11B or 11D, light leakage through the opening-and-closing-section boundary 33 is reduced compared with the comparative example as indicated by a sign G22 or G24 in the figure. In the example shown in FIG. 11A, light leakage through the opening-and-closing-section boundary 33 is further reduced as indicated by a sign G21 in the figure. Furthermore, when the examples shown in FIGS. 11B and 11D are compared, the amount of light leakage through the opening-and-closing-section boundary 33 is reduced in the example shown in FIG. 11D)(θ=135° compared with the example shown in FIG. 11B)(θ=45°. This is because when attention is focused on an orientation of the liquid crystal molecules 350 at the center of cell thickness, while θ is 0 degrees at the center of cell thickness in the example shown in FIG. 11B, θ is 90 degrees at the center of cell thickness in the example shown in FIG. 11D. In other words, since each of polarization transmission axes Apo of the polarizing plates 361 and 362 is in a direction of θ=+45° or −45°, the orientation of the liquid crystal molecules 350 at the center of cell thickness is desirably twisted. Consequently, in the case of TN alignment shown in FIGS. 11A to 11D, light leakage is reduced near 135°≦θ≦180° (0° compared with near 45°≦θ≦90°.

### (Arrangement of Polarization Transmission Axis and Absorption Axis of Each Polarizing Plate of Each of Display Section 20 and Liquid Crystal Barrier 30)

In the liquid crystal barrier 30 of the embodiment, the orientation of the liquid crystal molecules 350 is desirably substantially equal to (preferably equal to) a horizontal-line direction (here, X-axis direction) or a vertical-line direction (here, Y-axis direction) of the display section 20. As described below, such a configuration allows some components of a stereoscopic display device as a whole or a liquid crystal barrier to be eliminated (unnecessary) in conjunction with a direction of each polarization transmission axis in the display section 20, leading to reduction in cost (reduction in size or thickness).

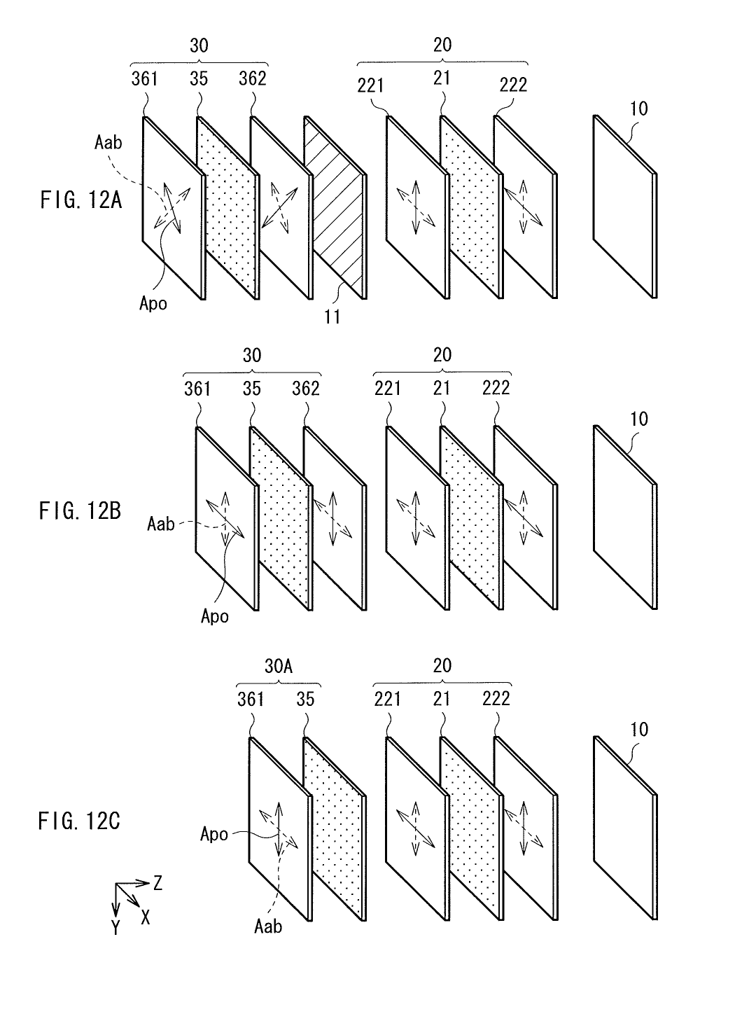

Specifically, when the orientation of the liquid crystal molecules 350 in the liquid crystal layer 35 of the liquid crystal barrier 30 is different from each of the horizontal-line direction (X-axis direction) and the vertical-line direction (Y-axis direction) of the display section 20, a λ/2 retardation film 11 needs to be provided to suppress reduction in luminance, for example, as shown in FIG. 12A. In other words, each of a pair of polarizing plates 221 and 222 of the display section 20 (liquid crystal display section) having the liquid crystal layer 21 has a polarization transmission axis Apo (solid line) and an absorption axis Aab (broken line) typically in a horizontal-line or vertical-line direction each, as shown in FIG. 12A. Specifically, the polarizing plate 222 on a light-input side has a polarization transmission axis Apo in a horizontal-line direction (X-axis direction) and an absorption axis Aab in a vertical-line direction (Y-axis direction). In contrast, the polarizing plate 221 on a light-output side has a polarization transmission axis Apo in a vertical-line direction (Y-axis direction) and an absorption axis Aab in a horizontal-line direction (X-axis direction). As a result, when the orientation of the liquid crystal molecules 350 in the liquid crystal layer 35 is set as above, the polarization transmission axis Apo and the absorption axis Aab of each of a pair of the polarizing plates 361 and 362 of the liquid crystal barrier 30 are accordingly directed as in the following. That is, as shown in the figure, each of directions of the polarization transmission axis Apo and the absorption axis Aab of the polarizing plate 361 or 362 needs to have an angle with respect to each of the horizontal-line direction (X-axis direction) and the vertical-line direction (Y-axis direction). In this case, it is therefore necessary to provide the λ/2 retardation film 11 between the display section 20 and the liquid crystal barrier 30 so as to rotate a polarization direction of light outputted from the polarizing plate 221 before the light is inputted to the polarizing plate 362.

On the other hand, when the orientation of the liquid crystal molecules 350 in the liquid crystal layer 35 of the liquid crystal barrier 30 is substantially equal to (equal to) each of the horizontal-line direction (X-axis direction) and the vertical-line direction (Y-axis direction) of the display section 20, the λ/2 retardation film 11 need not be provided, for example, as shown in FIGS. 12B and 12C. Specifically, in the example shown in FIG. 12B, since respective directions of the polarization transmission axis Apo and the absorption axis Aab are the same between the polarizing plates 221 and 362, the λ/2 retardation film 11 is unnecessary.

This makes it possible to achieve reduction in cost (reduction in size or thickness) in correspondence to such elimination of the λ/2 retardation film 11 compared with the example shown in FIG. 12A.

In the example shown in FIG. 12C, first, respective directions of the polarization transmission axis Apo and the absorption axis Aab of the polarizing plate 221 or 222 are rotated by 90 degrees with respect to those in the example shown in FIG. 12A or 12B. Specifically, in the polarizing plate 222, the polarization transmission axis Apo (solid line) is in a vertical-line direction (Y-axis direction), and the absorption axis Aab (broken line) is in a horizontal-line direction (X-axis direction). In contrast, in the polarizing plate 221, the polarization transmission axis Apo is in a horizontal-line direction (X-axis direction), and the absorption axis Aab is in a vertical-line direction (Y-axis direction). Consequently, the liquid crystal barrier 30A need not have the polarizing plate 362 on a light-input side, and has the polarizing plate 361 on a light-output side, of which respective directions of the polarization transmission axis Apo and the absorption axis Aab are rotated by 90 degrees with respect to those of the polarizing plate 361 of the liquid crystal barrier 30. This makes it possible to achieve further reduction in cost (reduction in size or thickness) in correspondence to such elimination of the polarizing plate 362 compared with the example shown in FIG. 12B.

As described hereinbefore, in the embodiment, the liquid crystal barrier 30 is designed such that the orientation of the liquid crystal molecules 350 under no voltage application in the liquid crystal element is different from the extending direction of the opening-and-closing sections 31 or 32 in a light barrier surface, allowing the liquid crystal molecules 350 to be hardly changed in orientation during voltage application. This makes it possible to reduce light leakage through the opening-and-closing boundary 33, leading to improvement in display contrast (contrast on the liquid crystal barrier 30) and thus improvement in image quality.

### Second Embodiment

Next, a second embodiment of the disclosure is described. The same components as those in the first embodiment are designated by the same symbols, and description of them is appropriately omitted.

### [Configuration of Liquid Crystal Barriers 30B, 30C, and 30D]

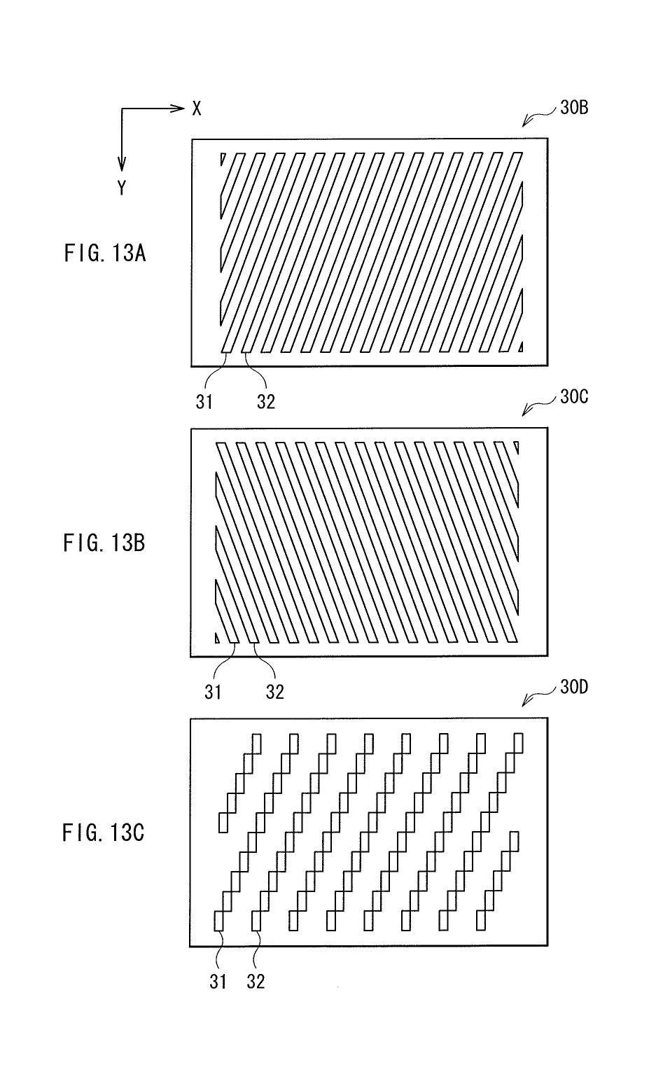

FIGS. 13A to 13C illustrate planar configuration examples of liquid crystal barriers (liquid crystal barriers 30B, 30C, and 30D) of a stereoscopic display device of the embodiment. In the liquid crystal barriers 30B, 30C, and 30D of the embodiment, an extending direction of opening-and-closing sections 31 or 32 is an oblique direction different from each of a horizontal-line direction (X-axis direction) and a vertical-line direction (Y-axis direction) of a display section 20 unlike the liquid crystal barrier 30 in the first embodiment. Other configurations (configurations of the display section 20 and a backlight section 10) of the stereoscopic display device are the same as those in the first embodiment.

Specifically, the liquid crystal barrier 30B or 30C shown in FIG. 13A or 13B has a plurality of opening-and-closing sections 31 and 32 each having a rectangular shape and extending in an oblique direction in a light barrier surface (X-Y plane) (oblique barrier type). In detail, the liquid crystal barrier 30B of FIG. 13A has opening-and-closing sections 31 and 32 each extending in a right oblique direction as viewed from a viewer in the light barrier surface. In contrast, the liquid crystal barrier 30C of FIG. 13B has opening-and-closing sections 31 and 32 each extending in a left oblique direction as viewed from a viewer in the light barrier surface.

On the other hand, the liquid crystal barrier 30D of FIG. 13C has opening-and-closing sections 31 and 32 each generally extending stepwise in an oblique direction in the light barrier surface (X-Y plane) (stepped-barrier type). While the sections extend in a right oblique direction as viewed from a viewer in the example of the stepped-barrier type, the sections may conversely extend in a left oblique direction as viewed from a viewer.

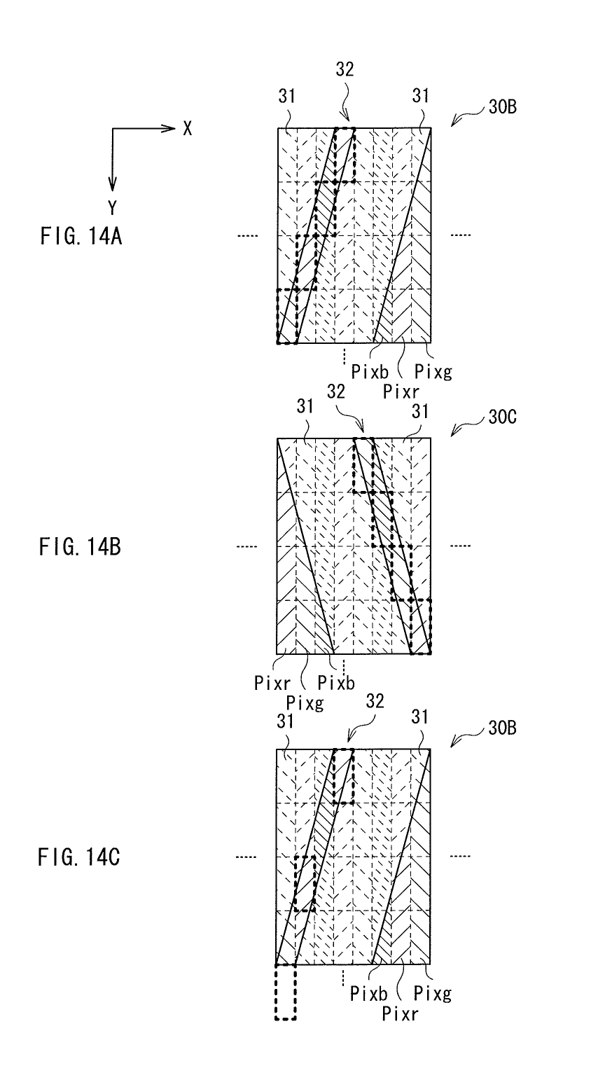

Next, FIGS. 14A to 14C are plan diagrams (X-Y plan diagrams) schematically illustrating configuration examples of the opening-and-closing sections 31 and 32 of the respective liquid crystal barriers 30B and 30C together with a pixel configuration example of the display section 20.

First, in the example shown in FIG. 14A or 14B, a red pixel Pixr, a green pixel Pixg, and a blue pixel Pixb are continuously viewed in order along an oblique direction from a viewer in an opening-and-closing section 32 extending in a right oblique or left oblique direction. On the other hand, in the example shown in FIG. 14C, a red pixel Pixr, a green pixel Pixg, and a blue pixel Pixb are discontinuously (intermittently) viewed in order along an oblique direction from a viewer in an opening-and-closing section 32 extending in a right oblique direction. However, a layout of red pixels Pixr, green pixels Pixg, and blue pixels Pixb in the display section 20, or a layout of the opening-and-closing sections 31 and 32 in the liquid crystal barrier 30B or 30C are not limited to these examples, and other layouts may be used.

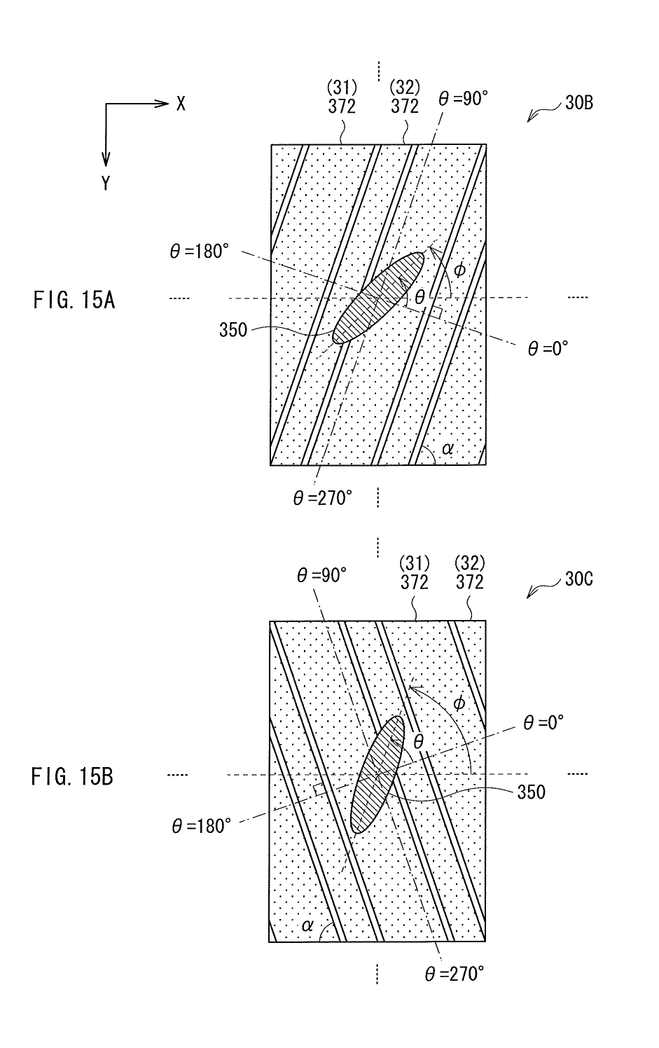

Even in the liquid crystal barriers 30B and 30C of the embodiment, an orientation of the liquid crystal molecules 350 under no voltage application is different from (has a predetermined angle to) an extending direction of the opening-and-closing sections 31 or 32 in a light barrier surface, in the same way as the liquid crystal barrier 30 in the first embodiment. In other words, an angle θ formed by an arrangement direction (oblique direction) of a plurality of opening-and-closing sections 31 or 32 and the orientation of the liquid crystal molecules 350 has a value different from 90 or 270 degrees as in the liquid crystal barriers 30B and 30C shown in FIGS. 15A and 15B. In the figures, an angle φ represents an angle formed by a horizontal-line direction (here, X-axis direction) of the display section 20 and the orientation of the liquid crystal molecules 350 under no voltage application. An angle α represents an angle formed by the horizontal-line direction (X-axis direction) of the display section 20 and the extending direction (oblique direction) of the opening-and-closing sections 31 or 32 (transparent electrodes 372), for example, an angle satisfying tan α=3)(α≈71.5651°).

When the liquid crystal molecules 350 are in TN alignment, the liquid crystal barriers 30B and 30C of the embodiment are desirably configured as follows. That is, an angular direction given by the extending direction (oblique direction) of the opening-and-closing sections 31 or 32 with respect to a vertical-line direction (here, Y-axis direction) of the display section 20 is desirably the same (rotational direction) as a twisted direction of the liquid crystal molecules 350 as viewed from a light output side (viewer side).

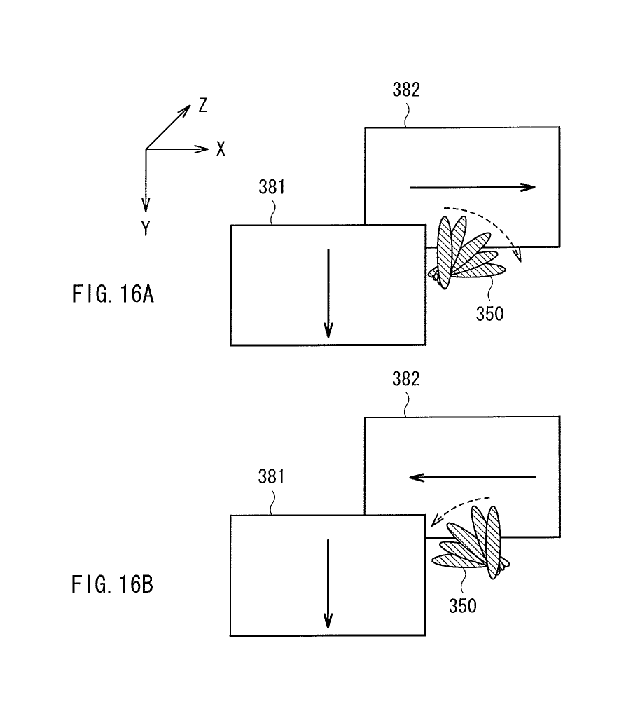

Specifically, in the liquid crystal barrier 30B shown in FIG. 15A, since the angular direction given by the extending direction (right oblique direction) of the opening-and-closing sections 31 or 32 is a clockwise direction, the twisted direction of the liquid crystal molecules 350 is desirably the clockwise direction as viewed from a light output side. In other words, the liquid crystal molecules 350 are desirably aligned in a right-hand direction, for example, as shown in FIG. 16A. In the liquid crystal barrier 30C shown in FIG. 15B, since the angular direction given by the extending direction (left oblique direction) of the opening-and-closing sections 31 or 32 is a counterclockwise direction, the twisted direction of the liquid crystal molecules 350 is desirably the counterclockwise direction as viewed from a light output side. In other words, the liquid crystal molecules 350 are desirably aligned in a left-hand direction, for example, as shown in FIG. 16B. In FIGS. 16A and 16B, arrows in alignment films 381 and 382 represent rubbing directions in manufacturing.

### [Effects of Liquid Crystal Barriers 30B and 30C]

Even in the liquid crystal barrier 30B or 30C of the embodiment, the orientation of the liquid crystal molecules 350 under no voltage application is different from (has a predetermined angle to) the extending direction of the opening-and-closing sections 31 or 32 in a light barrier surface, as described before. Consequently, as in the liquid crystal barrier 30, when an oblique electric-field is generated during voltage application in a boundary region (opening-and-closing-section boundary 33) between the opening-and-closing sections 31 and 32, the orientation of the liquid crystal molecules 350 is hardly changed, leading to reduction in light leakage through the opening-and-closing boundary 33.

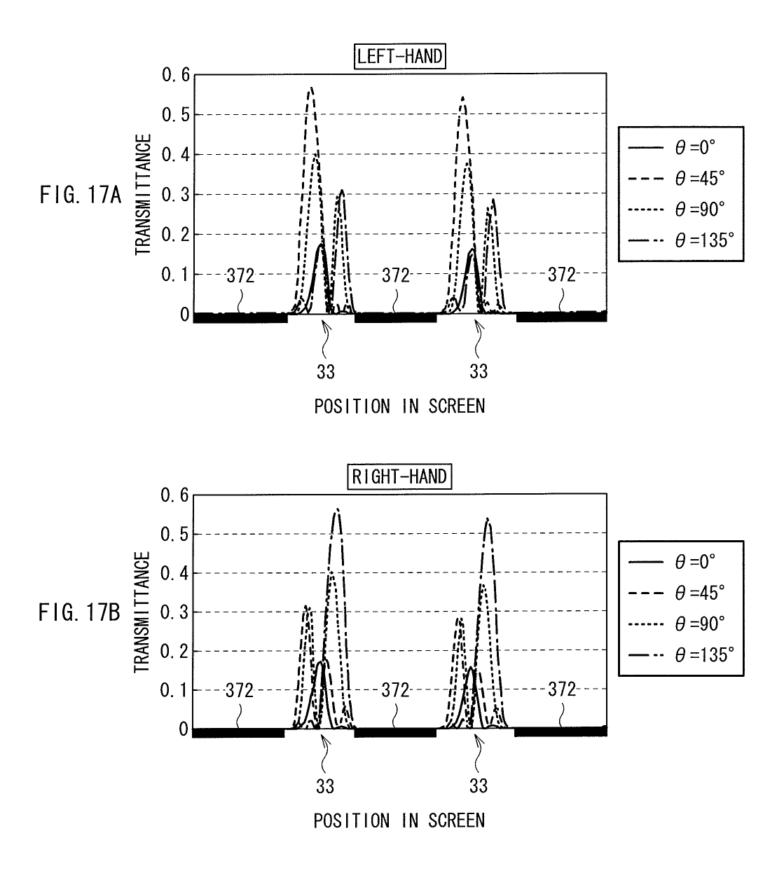

When the liquid crystal molecules 350 are in TN alignment, an angular direction given by the extending direction (oblique direction) of the opening-and-closing sections 31 or 32 with respect to the vertical-line direction of the display section 20 and a twisted direction of the liquid crystal molecules 350 as viewed from a light output side are the same (the same rotational direction), the following effect occurs. That is, light leakage through the opening-and-closing-section boundary 33 is further reduced according to the following reason. Specifically, in the case of TN alignment, the orientation of the liquid crystal molecules 350 at the center of cell thickness is desirably twisted due to influence of a traverse electric-field as described in the first embodiment. Consequently, even in the following example for TN alignment (FIGS. 17A and 17B to 19A and 19B), light leakage is reduced near 135°≦θ≦180° (0°) compared with near 45°≦θ≦90°.

FIGS. 17A and 17B illustrate an example of a relationship between the orientation of the liquid crystal molecules 350 and transmittances at various points in a screen in each of the liquid crystal barriers 30B and 30C, where FIG. 17A illustrates a case of the liquid crystal molecules 350 twisted to left, and FIG. 17B illustrates a case of the liquid crystal molecules 350 twisted to right.

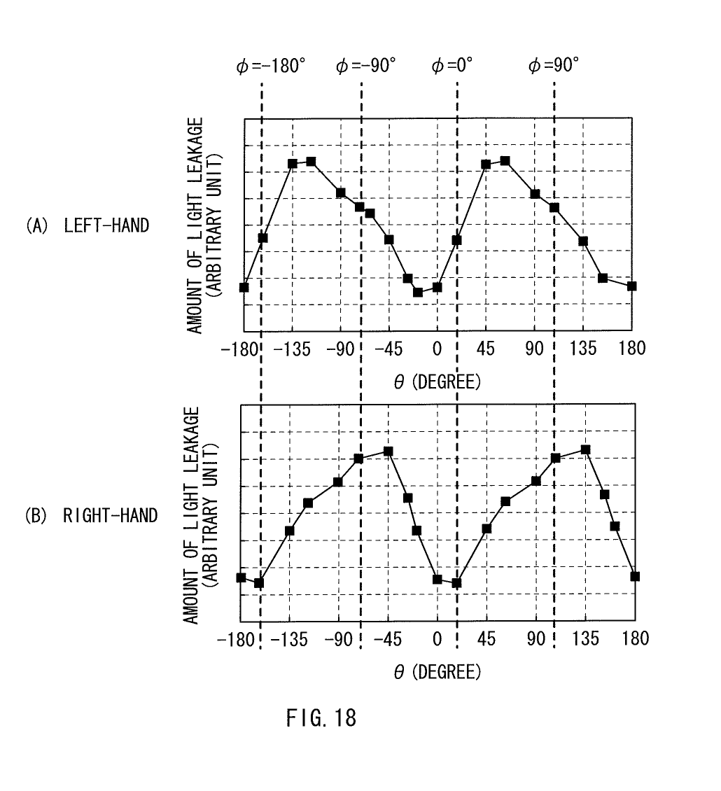

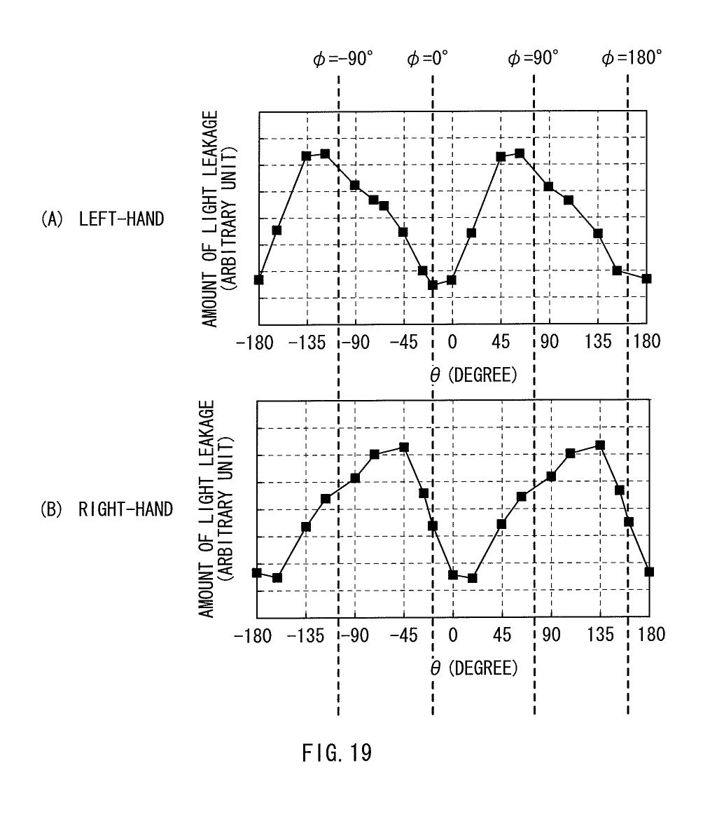

FIGS. 18A and 18B illustrate an example of a relationship between the orientation of the liquid crystal molecules 350 and the amount of light leakage in the liquid crystal barrier 30B, and FIGS. 19A and 19B illustrate an example of a relationship between the orientation of the liquid crystal molecules 350 and the amount of light leakage in the liquid crystal barrier 30C. FIG. 18A or 19A illustrates a case of the liquid crystal molecules 350 twisted to left, and FIG. 18B or 19B illustrates a case of the liquid crystal molecules 350 twisted to right.

From FIGS. 17A and 17B to 19A and 19B, in the case of θ=90° or −90° according to the comparative example, a large amount of light leakage (light escape) occurs through the opening-and-closing-section boundary 33. In contrast, in the case of θ=0° or 135° (θ≠90° or −90°) according to the example of the embodiment, light leakage through the opening-and-closing-section boundary 33 is reduced compared with the comparative example. Particularly, in the case of θ=0° (180°), light leakage through the opening-and-closing-section boundary 33 is further reduced. Furthermore, when the angular direction given by the extending direction (oblique direction) of the opening-and-closing sections 31 or 32 with respect to the vertical-line direction of the display section 20 and the twisted direction of the liquid crystal molecules 350 as viewed from a light output side are the same (the same rotational direction), light leakage through the opening-and-closing-section boundary 33 is still further reduced. Specifically, in the liquid crystal barrier 30B shown in FIGS. 18A and 18B, light leakage is still further reduced in the case of the liquid crystal molecules 350 twisted to right compared with the case of the molecules 350 twisted to left. Conversely, in the liquid crystal barrier 30C shown in FIGS. 19A and 19B, light leakage is still further reduced in the case of the liquid crystal molecules 350 twisted to left compared with the case of the molecules 350 twisted to right.

As described hereinbefore, even in the embodiment, the same advantage may be obtained through the same effects as in the first embodiment. In other words, light leakage through the opening-and-closing boundary 33 may be reduced, leading to improvement in display contrast and thus improvement in image quality.

### Modification

Next, a common modification between the first and second embodiments is described. The same components as those in the embodiments are designated by the same symbols, and description of them is appropriately omitted.

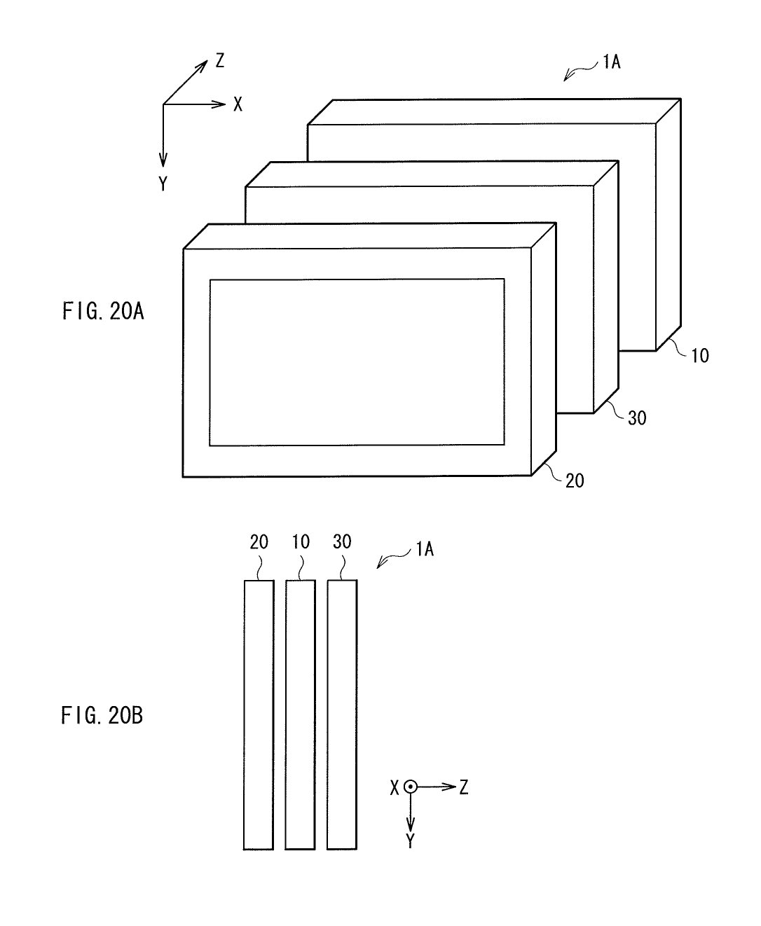

FIGS. 20A and 20B are an exploded perspective diagram (FIG. 20A) and a side diagram (Y-Z side diagram: FIG. 20B)), respectively, illustrating a general configuration of a stereoscopic display device (stereoscopic display device 1A) according to the modification.

In the stereoscopic display device 1A according to the modification, a backlight section 10, a liquid crystal barrier 30, and a display section 20 are disposed in this order along a Z-axis direction, unlike the stereoscopic display device 1 according to the embodiments. In other words, light is emitted from the backlight section 10 and received by a viewer through the liquid crystal barrier 30 and the display section 20 in this order.

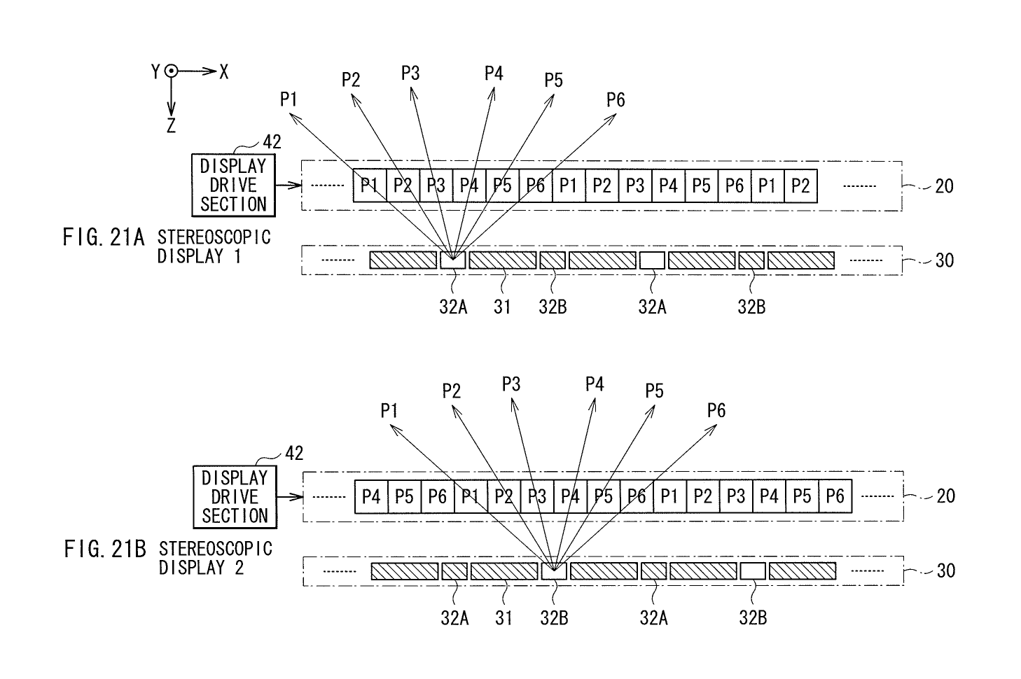

Specifically, in the stereoscopic display device 1A, light emitted from the backlight section 10 is first inputted to the liquid crystal barrier 30, for example, as shown in FIG. 21A (stereoscopic display 1) and FIG. 21B (stereoscopic display 2). Then, the light is partially transmitted by an opening-and-closing section 32A or 32B. The display section 20 modulates the transmitted light and thus outputs six eyepoint images.

Even in the stereoscopic display device 1A having such a configuration, the same advantage may be obtained through the same effects as in the embodiments.

### Other Modifications

While the disclosure has been described with the embodiments and the modifications hereinbefore, the disclosure is not limited to the embodiments and the like, and various modifications or alterations may be made.

For example, while the video signal S0 includes six eyepoint images in the embodiments and the like, this is not limitative. For example, the signal may include five or less eyepoint images or seven or more eyepoint images.

In addition, while the embodiments and the like have been described with specific examples of the orientation of the liquid crystal molecules and the extending direction of the opening-and-closing section (extending direction of the transparent electrodes 372) in the liquid crystal barrier, the directions and a combination thereof are not limited to those in the embodiments and the like.

Furthermore, while the embodiments and the like have been described on a case where the opening-and-closing sections 32A and 32B are time-divisionally alternately opened for image display, this is not limitative, and the display section may display a plurality of eyepoint images merely space-divisionally.

In addition, while the embodiments and the like have been described on a case where the display section 20 is configured of a liquid crystal display section and the backlight section 10 is provided as a light source section, this is not limitative. In other words, another type of display section (for example, a self-luminous display section such as organic EL (Electro Luminescence) display or PDP (Plasma Display Panel)) may be provided in place of the display section 20 and the backlight section 10.

The present disclosure contains subject matter related to that disclosed in Japanese Priority Patent Application JP 2010-179557 filed in the Japan Patent Office on Aug. 10, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. A display device comprising:
a display section; and
a liquid crystal barrier section including a plurality of opening-and-closing sections each comprising a liquid crystal element to extend along a predetermined direction in a light barrier surface,
wherein an orientation, of liquid crystal molecules, in a light barrier plane, under no voltage application in the liquid crystal element is different from an extending direction of each of the plurality of opening-and-closing sections.

2. The display device according to claim 1, wherein the orientation and the extending direction are approximately orthogonal to each other in the light barrier plane.

3. The display device according to claim 1, wherein the extending direction is an oblique direction different from both a horizontal-line direction and a vertical-line direction of the display section.

4. The display device according to claim 3, wherein the liquid crystal molecules are in Twisted Nematic orientation mode, and
a rotational angular direction from the vertical-line direction toward the oblique direction is equal to a twisting direction of the liquid crystal molecules with a liquid crystal molecule close to a light output side as a starting point.

5. The display device according to claim 3, wherein the orientation is substantially equal to the horizontal-line direction or the vertical-line direction.

6. The display device according to claim 1, wherein the extending direction is substantially equal to the vertical-line direction of the display section.

7. The display device according to claim 1, wherein the display section comprises a liquid crystal display.

8. The display device according to claim 1, wherein the liquid crystal element includes:
a pair of substrates;
a liquid crystal layer provided between the pair of substrates to contain the liquid crystal molecules;
a common electrode provided on one of the pair of substrates on a liquid-crystal-layer side; and
a plurality of electrodes provided on the other of the pair of substrates on a liquid-crystal-layer side, to delimit the plurality of opening-and-closing sections, and
the orientation is defined as an orientation of the liquid crystal molecules existing in a region close to the plurality of electrodes.

9. A display device comprising:
a display section; and
a barrier section including a plurality of opening-and-closing sections each comprising a liquid crystal element,
wherein an orientation of liquid crystal molecules in the liquid crystal element is different from an extending direction of each of the plurality of opening-and-closing sections.

10. The display device according to claim 9, wherein each of the plurality of opening-and-closing sections has an electrode allowing transmittance control of the liquid crystal element, and
an orientation of the liquid crystal molecules is different from an extending direction of the electrode.

11. A liquid crystal barrier device comprising a plurality of opening-and-closing sections each comprising a liquid crystal element to extend along a predetermined direction in a light barrier plane,
wherein an orientation, of liquid crystal molecules, in a light barrier plane, under no voltage application in the liquid crystal element is different from an extending direction of each of the plurality of opening-and-closing sections.

12. A display device with a display section and a liquid crystal barrier section, the liquid crystal barrier section comprising:
a pair of substrates,
a liquid crystal layer provided between the pair of substrates to contain liquid crystal molecules,
a common electrode provided on one of the pair of substrates on a liquid-crystal-layer side; and
a plurality of electrodes provided on the other of the pair of substrates on a liquid-crystal-layer side, to extend along a predetermined direction,
wherein an orientation, of the liquid crystal molecules, in a substrate plane, under no voltage application is different from an extending direction of each of the plurality of electrodes.

13. A liquid crystal barrier device comprising:
a pair of substrates;
a liquid crystal layer provided between the pair of substrates to contain liquid crystal molecules;
a common electrode provided on one of the pair of substrates on a liquid-crystal-layer side; and
a plurality of electrodes provided on the other of the pair of substrates on a liquid-crystal-layer side, to extend along a predetermined direction,
wherein an orientation, of the liquid crystal molecules, in a substrate plane, under no voltage application is different from an extending direction of each of the plurality of electrodes.
